(19) United States
(12) Patent Application Publication
(10) Pub. No.: US 2025/0193697 A1
(43) Pub. Date: Jun. 12, 2025

(54) CONFIGURATION INFORMATION SENDING METHOD AND APPARATUS, AND CONFIGURATION DETERMINATION METHOD AND APPARATUS

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/281,434

(22) PCT Filed: Mar. 12, 2021
(86) PCT No.: PCT/CN2021/080435

§ 371 Date: Mar. 26, 2024

(51) Int. Cl. H04W 24/02; H04W 68/02; H04W 76/38

(52) U.S. Cl. CPC H04W 24/02; H04W 68/02; H04W 76/38

(57) ABSTRACT

The present disclosure relates to a configuration information method, including: sending configuration information to a multi-card terminal; where the configuration information is used for the terminal to determine a configuration for a first SIM card to leave a first communication system of the base station when a communication conflict occurs between the first SUM card and a second SIM card during communicating with the base station through the first SIM card. According to the present disclosure, the base station sends the configuration information to the multi-card terminal, and the base station can determine how the first SIM card to leave the first communication system, thus when the first SIM card leaves the first communication system according to the configuration, the base station can determine that the communication conflict occurs between the first SIM card and the second SIM card in the terminal, which causes the first SIM card to return to the first SIM card or boost power, which is not only beneficial to avoiding waste of communication resources, but also improves controllability for the first SIM card to leave the first communication system.

### TECHNICAL FIELD

The present disclosure relates to the technical field of communication, and in particular, to a configuration information sending method, a configuration determination method, a configuration information sending apparatus, a configuration determination apparatus, a communication device, and a computer-readable storage medium.

### BACKGROUND

In a multi-card terminal, a plurality of SIM (Subscriber Identity Module) cards can be set, and the terminal can communicate through the plurality of SIM cards. However, during communication, communication conflicts may occur between the plurality of SIM cards, which will affect communication effect of the terminal.

For example, when a terminal uses a SIM card #1 to communicate with a base station A, a SIM card #2 requires to communicate with a base station B. In such case, if the terminal chooses the SIM card #1 to leave a communication system of the base station A and uses the SIM card #2 to communicate with the base station B, since the base station A does not know why the SIM card #1 left, the base station A will mistake that there is a problem with the SIM card #1, such as shadow fading, and will attempt to page the SIM card #1 and even to change a power of communication with the SIM card #1.

However, the SIM card #1 leaves the communication system of the base station A not because that there is a problem with the SIM card #1, but because it is decided by the terminal according to its own implementation. Thus, even though the base station A attempts to page the SIM card #1 or even to boost the power, the SIM card #1 will not return to the communication system immediately. Consequently, resources in the communication system are wasted.

### SUMMARY

In view of this, embodiments of the present disclosure provide a configuration information sending method, a configuration determination method, a configuration information sending apparatus, a configuration determination apparatus, a communication device, and a computer-readable storage medium, so as to solve technical problems in related arts.

According to a first aspect of embodiments of the present disclosure, a configuration information sending method is provided, where the method is performed by a base station, and the method includes:
sending configuration information to a multi-card terminal;
where the configuration information is used for the terminal to determine a configuration for a first SIM card to leave a first communication system of the base station when a communication conflict occurs between the first SIM card and a second SIM card during communicating with the base station through the first SIM card.

According to a second aspect of embodiments of the present disclosure, a configuration determination method is provided, where the method is performed by a multi-card terminal, and the method includes:
receiving configuration information sent by a base station;
determining, according to the configuration information, a configuration for a first SIM card to leave a first communication system of the base station when a communication conflict occurs between the first SIM card and a second SIM card during communicating with the base station through the first SIM card.

According to a third aspect of embodiments of the present disclosure, a configuration information sending apparatus is provided, where the apparatus is applied to a base station, and the apparatus includes:
a configuration-sending module, configured to send configuration information to a multi-card terminal;
where the configuration information is used for the terminal to determine a configuration for a first SIM card to leave a first communication system of the base station when a communication conflict occurs between the first SIM card and a second SIM card during communicating with the base station through the first SIM card.

According to a fourth aspect of the present disclosure, a configuration determination apparatus is provided, where the apparatus is applied to a multi-card terminal, the terminal is provided with a plurality of SIM cards, the plurality of SIM cards at least include a first SIM card and a second SIM card, and the apparatus includes:
a configuration-receiving module, configured to receive configuration information sent by a base station;
a configuration-determining module, configured to determine, according to the configuration information, a configuration for the first SIM card to leave a first communication system of the base station when a communication conflict occurs between the first SIM card and the second SIM card during communicating with the base station through the first SIM card.

According to a fifth aspect of embodiments of the present disclosure, a communication device is provided, where the device includes:
a processor;
a memory configured to store a computer program;
when the computer program is executed by the processor, the above configuration information sending method is implemented.

According to a sixth aspect of embodiments of the present disclosure, a communication device is provided, where the device includes:
a processor;
a memory configured to store a computer program;
when the computer program is executed by the processor, the above configuration determination method is implemented.

According to a seventh aspect of embodiments of the present disclosure, a computer-readable storage medium is provided, where the computer-readable storage medium is configured to store a computer program, and when the computer program is executed by a processor, steps in the above configuration information sending method are implemented.

According to an eighth aspect of embodiments of the present disclosure, a computer-readable storage medium is provided, where the computer-readable storage medium is configured to store a computer program, and when the computer program is executed by a processor, steps in the above configuration determination method are implemented.

According to embodiments of the present disclosure, configuration information is sent to a multi-card terminal through a base station, and since the configuration information is determined by the base station, the base station controls, through the configuration information, an operation for a first SIM card to leave a first communication system, and can also determine, based on the configuration information, how the first SIM card to leave the first communication system.

In such way, when the terminal uses the first SIM card to communicate with the base station, and if in this meantime, there is a communication conflict between the first SIM card and the second SIM card, the terminal can control the first SIM card to leave the first communication system of the base station according to the configuration, and when the first SIM card leaves the communication system, the terminal can communicate in a second communication system through a second SIM card, such as receiving pages, responding to pages, receiving system information, tracking area updates, etc.

Since the base station can determine how the first SIM card to leave the first communication system, when the first SIM card leaves the first communication system according to the configuration, the base station can determine that the communication conflict occurs between the first SIM card and the second SIM card in the terminal, which causes the first SIM card to leave the first communication system. Further, the base station can wait the first SIM card to return to the first communication system according to the configuration, and does not need to page the first SIM card or boost power, which is not only beneficial to avoiding waste of communication resources, but also improves controllability for the first SIM card to leave the first communication system.

### BRIEF DESCRIPTION OF DRAWINGS

In order to describe technical solutions in embodiments of the present disclosure more clearly, drawings needed in the description of the embodiments will be briefly introduced below. Obviously, the drawings in the following description are only some embodiments of the disclosure. For those of ordinary skills in the art, other drawings can be obtained according to these drawings without making creative efforts.

FIG. 1 is a schematic flowchart of a configuration information sending method according to an embodiment of the present disclosure.

FIG. 2 is a schematic flowchart of a configuration determination method according to an embodiment of the present disclosure.

FIG. 3 is a schematic block diagram of a configuration information sending apparatus according to an embodiment of the present disclosure.

FIG. 4 is a schematic block diagram of a configuration determination apparatus according to an embodiment of the present disclosure.

FIG. 5 is a schematic block diagram of a device for sending configuration information according to an embodiment of the present disclosure.

FIG. 6 is a schematic block diagram of a device for determining a configuration according to an embodiment of the present disclosure.

### DETAILED DESCRIPTION

In the following, technical solutions in embodiments of the present disclosure will be clearly and completely described with reference to the accompanying drawings. Obviously, the described embodiments are only part of the embodiments of the present disclosure, but not all of the embodiments. Based on the embodiments in the present disclosure, all other embodiments obtained by those of ordinary skills in the art without making creative efforts belong to the scope of protection in the present disclosure.

The terminologies used in the embodiments of the present disclosure are for the purpose of describing specific embodiments only and are not intended to limit the embodiments of the present disclosure. Singular forms “a” and “said” used in the embodiments of the present disclosure and the appended claims are also intended to include plural forms, unless the context clearly indicates otherwise. It should also be understood that the term “and/or” as used herein refers to and includes any or all possible combinations of one or more associated listed items.

It should be understood that although the terms first, second, third, etc., may be used to describe various information in the embodiments of the present disclosure, these information should not be limited by these terms. These terms are only used to distinguish the same type of information from each other. For example, without departing from the scope of the embodiments of the present disclosure, first information may also be referred to as second information, and similarly, second information may also be referred to as first information. Depending on the context, words “if” or “under a circumstance of” as used herein can be interpreted as “when” or “upon” or “in response to determining”.

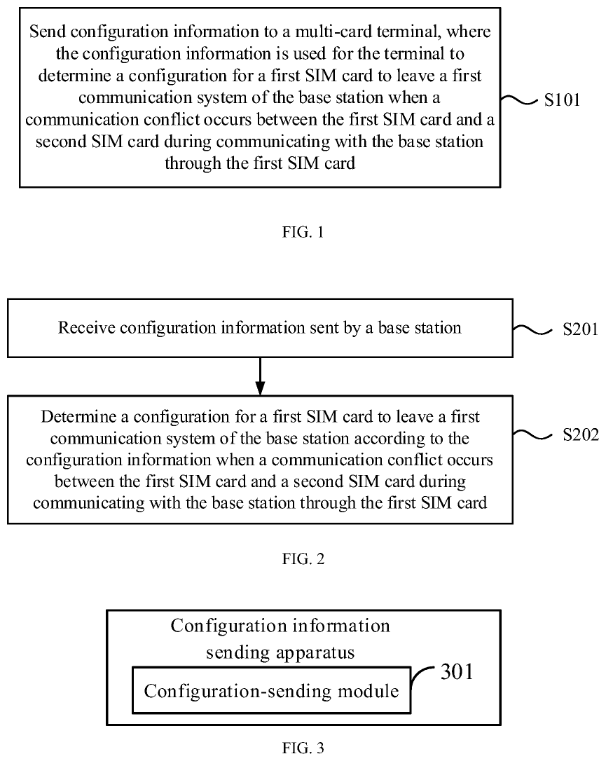

FIG. 1 is a schematic flowchart of a configuration information sending method according to an embodiment of the present disclosure. The configuration information sending method described by the present embodiment can be performed by a base station, and the base station includes but is not limited to a 4G base station, a 5G base station, a 6G base station. The base station can communicate with a terminal as a user equipment, including but not limited to mobile phones, tablet computers, wearable devices, sensors, Internet of Things devices and other communication devices.

In an embodiment, the terminal may be the terminal to which the configuration determination method in any subsequent embodiment applies.

In an embodiment, the base station may belong to a first communication system, the base station can communicate with the terminal, and the terminal may be a multi-card terminal and is provided with a plurality of SIM cards. In the following, a circumstance that the plurality of SIM cards include a first SIM card and a second SIM card will be mainly illustrated.

The first SIM card and the second SIM card do not refer to a certain SIM card, but refer to any two different SIM cards in the plurality of SIM cards. The SIM card may be a traditional SIM card, a USIM card, an eSIM card, etc.

As shown in FIG. 1, the configuration information sending method may include following steps:

In step S101, sending configuration information to a multi-card terminal;
where the configuration information is used for the terminal to determine a configuration for a first SIM card to leave a first communication system of the base station when a communication conflict occurs between the first SIM card and a second SIM card during communicating with the base station through the first SIM card.

In an embodiment, the base station can communication with the first SIM card in the terminal, where the base station belongs to a first communication system. The second SIM card in the terminal can communicate with another base station, and the other base station belongs to a second communication system. The first communication system and the second communication system may belong to a same operator network, or may belong to different operator networks.

In an embodiment, the configuration information can be generated by the base station, or can be specified by a protocol in advance. The base station sends the configuration information to the terminal for the terminal to determine the configuration. Specifically, the terminal can determine, when communicating with the base station through the first SIM card, the configuration for the first SIM card to leave the first communication system of the base station when the communication conflict occurs between the first SIM card and the second SIM card.

In an embodiment, the base station can pre-determine the configuration information, and then send the configuration information to the terminal through the first SIM card when establishing communication connection with the first SIM card; the base station can also determine the configuration information after establishing communication connection with the first SIM card, and then send the configuration information to the terminal through the first SIM card; and the base station can also send the configuration information to the terminal after receiving trigger information sent by the terminal.

The base station can multiplex existed signalling for carrying the configuration information to send to the terminal, or can create new signalling (such as specific signalling for sending the configuration information) for carrying the configuration information to send to the terminal. The signalling may be radio resource control (RRC) layer signalling, or may be media access control (MAC) layer signalling, or may be physical layer signalling, which can be specifically set according to needs.

According to embodiments of the present disclosure, configuration information is sent to a multi-card terminal through a base station, and since the configuration information is determined by the base station, the base station controls, through the configuration information, an operation for a first SIM card to leave a first communication system, and can also determine, based on the configuration information, how the first SIM card to leave the first communication system.

In such way, when the terminal uses the first SIM card to communicate with the base station, and if in the meantime, a communication conflict occurs between the first SIM card and the second SIM card, the first SIM card can be controlled according to the configuration to leave the first communication system of the base station, and in response to determining that the first SIM card leaves the communication system, the terminal can communicate in a second communication system through a second SIM card, such as receiving pages, responding to pages, receiving system information, tracking area updates, etc.

Since the base station can determine how the first SIM card to leave the first communication system, when the first SIM card leaves the first communication system according to the configuration, the base station can determine that the communication conflict occurs between the first SIM card and the second SIM card in the terminal, which causes the first SIM card to leave the first communication system. Further, the base station can wait the first SIM card to return to the first communication system according to the configuration, and does not need to page the first SIM card or boost power, which is not only beneficial to avoiding waste of communication resources, but also improves controllability for the first SIM card to leave the first communication system.

It is to be noted that, there may be two cases when the first SIM card leaves the first communication system.

One case refers to that a connected state between the first SIM card and the base station is disconnected, and the first SIM card enters an idle state or an inactive state.

The other case refers to that a current state between the first SIM card and the base station is the connected state, or the idle state, or the inactive state, and leaving the first communication system refers to that the first SIM card and the base station still remain the current state, but within a short period (for example, a period less than a preset time length) a downlink channel is not monitored, and no uplink transmission is performed.

In addition, the communication conflict occurring between the first SIM card and the second SIM card may refer to that the terminal determines that a communication conflict is currently occurring between the first SIM card and the second SIM card, or may refer to that the terminal predicts that a communication conflict is about to happen between the first SIM card and the second SIM card.

In an embodiment, the communication conflict between the first SIM card and the second SIM card includes but is not limited to following cases:
a conflict occurs between page information monitoring of the first SIM card and page information monitoring of the second SIM card, for example, paging occasions overlap with each other; and following cases mainly refer to that when the first SIM card performs a communication operation, the second SIM card needs to perform a communication operation:
a conflict occurs between the communication operation of the first SIM card and the paging information monitoring of the second SIM card;
a conflict occurs between the communication operation of the first SIM card and the paging information responding of the second SIM card;
a conflict occurs between the communication operation of the first SIM card and signal measuring of the second SIM card;
a conflict occurs between the communication operation of the first SIM card and system information receiving of the second SIM card; and/or
a conflict occurs between the communication operation of the first SIM card and tracking area updating of the second SIM card.

In an embodiment, sending the configuration information to the multi-card terminal includes:
in response to receiving trigger information for acquiring the configuration information sent by the terminal, sending the configuration information to the terminal.

In view of this, the base station can send the configuration information to the multi-card terminal after receiving the sent trigger information, which is beneficial to avoiding resources being wasted caused by that the base station sends the configuration information to the terminal when the terminal does not need the configuration information.

In some embodiments, the trigger information includes one of the following:
the terminal is provided with a plurality of SIM cards;
when the terminal uses the first SIM card to communicate with the base station, the second SIM card is in an ON state;
when the terminal uses the first SIM card to communicate with the base station, the second SIM card receives information of a service to be started (such as paging corresponding to the service); or
when the terminal uses the first SIM card to communicate with the base station, the communication conflict occurs between the first SIM card and the second SIM card.

In an embodiment, the trigger information sent by the terminal may be one of the above 4 cases. After receiving the trigger information, the base station can further analyse the specific trigger information, and send the configuration information to the terminal when the trigger information is target information, where the target information may be one or more of the above 4 cases.

For example, the target information may be that when the terminal uses the first SIM card to communicate with the base station, the communication conflict occurs between the first SIM card and the second SIM card, and the trigger information sent by the terminal to the base station is that the terminal is provided with a plurality of SIM cards, and the base station can determine that the received trigger information is not consistent with the target information, and will not send the configuration information to the terminal.

It is to be noted that, the trigger information may be sent by the terminal according to its own state. For example, when the second SIM card is in an OFF state, the reported trigger information is that the terminal is provided with a plurality of SIM cards; when the second SIM card is in an ON state but does not receive the information of the service to be started yet, the reported trigger information is that the second SIM card is in the ON state when the terminal uses the first SIM card to communicate with the base station; and so on.

The base station can determine an urgent level of the communication conflict between the first SIM card and the second SIM card in the terminal by analysing the trigger information. For example, when an urgent level of the received trigger information is higher than an urgent level of the target information, even though the trigger information is different from the target information, the base station can still send the configuration information to the terminal.

For example, the target information is that the second SIM card receives the information of the service to be started when the terminal uses the first SIM card to communicate with the base station, and the received trigger information is that the communication conflict occurs between the first SIM card and the second SIM card when the terminal uses the first SIM card to communicate with the base station, the base station can determine that the urgent level of the trigger information is higher than the urgent level of the target information, and send the configuration information to the terminal.

In an embodiment, the base station can send the trigger information to the base station for once, or can send the configuration information to the base station for several times as a state of the terminal changes. For example, when the trigger information is sent but no configuration information is received last time, the trigger information can be sent again.

For example, when the second SIM card is in an OFF state, the trigger information sent by the terminal to the base station may be that the terminal is provided with a plurality of SIM cards; when no configuration information is received, the terminal can send the trigger information to the base station again after the second SIM card turns to an ON state, and the sent trigger information is that the second SIM card is in the ON state when the terminal uses the first SIM card to communicate with the base station; when no configuration information is received, the terminal can send the trigger information to the base station again after the second SIM card receives the information of the service to be started, and the sent trigger information is that the second SIM card receives the information of the service to be started when the terminal uses the first SIM card to communicate with the base station; when no configuration information is received, the terminal can send the trigger information to the base station again when the communication conflict occurs between the first SIM card and the second SIM card, and the sent trigger information is that the communication conflict occurs between the first SIM card and the second SIM card when the terminal uses the first SIM card to communicate with the base station.

In some embodiments, the configuration for the first SIM card to leave the first communication system includes at least one of the following:
a condition for the first SIM card to leave the first communication system;
a determination manner of a period of time for the first SIM card to leave the first communication system; or
a determination manner of a cycle for the first SIM card to leave the first communication system.

In an embodiment, the configuration for the first SIM card to leave the first communication system may include the condition for the first SIM card to leave the first communication system. That is, when the condition is satisfied, the first SIM card can leave the first communication system, and when the condition is not satisfied, the first SIM card cannot leave the first communication system. In view of this, the base station can effectively control the first SIM card to leave the first communication system, and under what conditions the first SIM card can leave the first communication system.

In an embodiment, the configuration for the first SIM card to leave the first communication system may include the determination manner of the period of time for the first SIM card to leave the first communication system, and may include the determination manner of the cycle for the first SIM card to leave the first communication system, etc. That is, the base station can inform the terminal through the configuration information of how to determine the period of time and the cycle for the first SIM card to leave the first communication system, so as to effectively control how the first SIM card to leave the first communication system.

In some embodiments, when the communication conflict occurs between the first SIM card and the second SIM card, the first SIM card performs communication of a first service, the second SIM card performs communication of a second service, and the condition for the first SIM card to leave the first communication system includes at least one of:
a relation between an attribute of the first service and an attribute of the second service satisfies a first condition;
the attribute of the first service does not satisfy a second condition; or
the attribute of the second service satisfies a third condition.

It is to be noted that, a case that the first SIM card performs communication of the first service and the second SIM card performs communication of the second service refers to that the first SIM card is currently performing communication of the first service and the second SIM card is about to perform or is currently performing communication of the second service.

In some embodiments, the attribute includes one of the following:
a service priority, a service quality (or a quality-of-service class identifier, QCI) and a service identifier.

The service priority may be agreed by the base station and the terminal, or may also be specified by a protocol; the service identifier may specifically be a service name, or a code agreed by the terminal and the base station.

In an embodiment, the condition for the first SIM card to leave the first communication system can be determined based on the attribute of the first service and the attribute of the second service, which may specifically refer to that a relation between the attribute of the first service and the attribute of the second service satisfies a first condition.

Different attributes correspond to different first conditions. For example, when the attribute is the service priority, the first condition may be that the priority of the second service is higher than the priority of the first service, or a difference between the higher priority of the second service and the lower priority of the first service is greater than a specified difference; for example, when the attribute is the quality of service (QoS), the first condition may be a QoS of the second service is higher than a QoS of the first service, or a difference between a higher QCI of the second service and a lower QCI of the first service is greater than a specified value.

In an embodiment, the condition for the first SIM card to leave the first communication system may be determined based on the attribute of the first service, which may specifically refer to that the attribute of the first service does not satisfy a second condition, that is, when the attribute of the first service satisfies the second condition, the first SIM card will not leave the first communication system.

Different attributes correspond to different second conditions. For example, when the attribute is the service identifier, the second condition may be that the identifier of the first service is not a target identifier. For example, a service with the target identifier is a voice call service, then when the terminal uses the first SIM card to perform the voice call service, even though the communication conflict occurs between the first SIM card and the second SIM card, the first SIM card cannot leave the first communication system, so as to ensure quality of the voice call, and when a non-voice-call service is performed, the first SIM card can leave the first communication system, so as to allow the second SIM card to communicate in the second communication system.

In an embodiment, the condition for the first SIM card to leave the first communication system may be determined based on the attribute of the second service, which may specifically refer to that the attribute of the second service satisfies the third condition.

Different attributes correspond to different third conditions. For example, when the attribute is the priority of the service, the third condition may be that the priority of the second service is higher than a priority threshold. When the terminal uses the first SIM card to perform the voice call service with the base station, and the communication conflict occurs between the first SIM card and the second SIM card, then the first SIM card can leave the first communication system, so as to allow the second SIM card to communicate in the second communication system.

In some embodiments, when the communication conflict occurs between the first SIM card and the second SIM card, the first SIM card performs communication of a first service, the second SIM card performs communication of a second service, and the determination manner of the period of time for the first SIM card to leave the first communication system includes at least one of:
determining the period of time according to a relation between an attribute of the first service and an attribute of the second service;
determining the period of time according to the attribute of the first service; or
determining the period of time according to the attribute of the second service.

In an embodiment, when the communication conflict occurs between the first SIM card and the second SIM card, the terminal can control the first SIM card to leave the first communication system for a period of time, and use the second SIM card to communicate in the second communication system within the period of time, and then control the second SIM card to leave the second communication system after the period of time, and control the first SIM card to return to the first communication system.

In an embodiment, the period of time for the first SIM card to leave the first communication system can be determined based on a relation between the attribute of the first service and the attribute of the second service.

For example, the attribute is the service priority, and when the priority of the first service is lower than the priority of the second service, the period of time for the first SIM card to leave the first communication system can be determined as t1, and when the priority of the first service is higher than the priority of the second service, the period of time for the first SIM card to leave the first communication system can be determined as t2, where t2>t1. That is, higher the priority of the first service is, shorter the period of time of leaving is, which is beneficial to ensuring communication quality of services with higher priority.

In an embodiment, the period of time for the first SIM card to leave the first communication system can be determined based on the attribute of the first service.

For example, when the attribute is the identifier of the service, for an identifier of each service, a corresponding relation between the identifier and the period of time can be determined in advance. For example, the base station configures a first table for the terminal, where the first table includes corresponding relations between identifiers and periods of time, and the terminal can determine the period of time corresponding to the identifier of the first service according to the corresponding relations, so that when the communication conflict occurs between the first SIM card and the second SIM card, the terminal can control the first SIM card to leave the first communication system for the period of time, and use the second SIM card to communicate in the second communication system within the period of time, and after the period of time, control the first SIM card to return to the first communication system.

In an embodiment, the period of time for the first SIM card to leave the first communication system can be determined based on the attribute of the second service.

For example, when the attribute is the service quality, for an identifier of each service, a corresponding relation between the service quality and the period of time can be determined in advance. For example, the base station configures a second table for the terminal, where the second table includes corresponding relations between identifiers and periods of time, and the terminal can determine the period of time corresponding to the service quality of the second service according to the corresponding relations, so that when the communication conflict occurs between the first SIM card and the second SIM card, the terminal can control the first SIM card to leave the first communication system for the period of time, and use the second SIM card to communicate in the second communication system within the period of time, and after the period of time, control the first SIM card to return to the first communication system.

In some embodiments, when the communication conflict occurs between the first SIM card and the second SIM card, the first SIM card performs communication of a first service, the second SIM card performs communication of a second service, and the determination manner of the cycle for the first SIM card to leave the first communication system includes at least one of:
determining the cycle according to a relation between an attribute of the first service and an attribute of the second service;
determining the cycle according to the attribute of the first service; or
determining the cycle according to the attribute of the second service.

In an embodiment, when the communication conflict occurs between the first SIM card and the second SIM card, the terminal can control the first SIM card to leave the first communication system periodically, and use the second SIM card to communicate in the second communication system during a cycle when the first SIM card left the first communication system, and then control the second SIM card to leave the second communication system after the cycle, and control the first SIM card to return to the first communication system.

In an embodiment, the cycle for the first SIM card to leave the first communication system can be determined based on a relation between the attribute of the first service and the attribute of the second service.

For example, the attribute is the service priority, and when the priority of the first service is lower than the priority of the second service, the cycle for the first SIM card to leave the first communication system can be determined as T1, and when the priority of the first service is higher than the priority of the second service, the cycle for the first SIM card to leave the first communication system can be determined as T2, where T2>T1. That is, higher the priority of the first service is, shorter the cycle of leaving is, which is beneficial to ensuring communication quality of services with higher priority.

In an embodiment, the cycle for the first SIM card to leave the first communication system can be determined based on the attribute of the first service.

For example, when the attribute is the identifier of the service, for an identifier of each service, a corresponding relation between the identifier and the cycle can be determined in advance. For example, the base station configures a third table for the terminal, where the third table includes corresponding relations between identifiers and cycles, and the terminal can determine the cycle corresponding to the identifier of the first service according to the corresponding relations, so that when the communication conflict occurs between the first SIM card and the second SIM card, the terminal can control the first SIM card to leave the first communication system based on the cycle.

In an embodiment, the cycle for the first SIM card to leave the first communication system can be determined based on the attribute of the second service.

For example, when the attribute is the service quality, for an identifier of each service, a corresponding relation between the service quality and the cycle can be determined in advance. For example, the base station configures a fourth table for the terminal, where the fourth table includes corresponding relations between identifiers and cycles, and the terminal can determine the cycle corresponding to the service quality of the second service according to the corresponding relations, so that when the communication conflict occurs between the first SIM card and the second SIM card, the terminal can control the first SIM card to leave the first communication system based on the cycle.

It is to be noted that, the above corresponding relations can be presented in a form of tables, or can also be presented in other forms according to needs.

FIG. 2 is a schematic flowchart of a configuration determination method according to an embodiment of the present disclosure. The configuration determination method described in the present embodiment can be performed by a terminal, where the terminal includes but is not limited to mobile phones, tablet computers, wearable devices, sensors, Internet of Things devices and other communication devices. The terminal can serve as a user equipment to communicate with a base station, where the base station includes but is not limited to a 4G base station, a 5G base station and a 6G base station.

In an embodiment, the base station may be the base station to which the configuration information sending method in any previous embodiment applies.

In an embodiment, the base station may belong to a first communication system, the base station can communicate with the terminal, the terminal may be a multi-card terminal and is provided with a plurality of SIM cards. In the following, a circumstance that the plurality of SIM cards include a first SIM card and a second SIM card will be mainly illustrated.

The first SIM card and the second SIM card do not refer to a certain SIM card, but refer to any two different SIM cards in the plurality of SIM cards. The SIM card may be a traditional SIM card, a USIM card, an eSIM card, etc.

As shown in FIG. 2, the configuration determination method may include following steps:
In step S201, receiving configuration information sent by a base station;
In step S202, determining a configuration for a first SIM card to leave a first communication system of the base station according to the configuration information when a communication conflict occurs between the first SIM card and a second SIM card during communicating with the base station through the first SIM card.

In an embodiment, the base station can communication with the first SIM card in the terminal, where the base station belongs to a first communication system. The second SIM card in the terminal can communicate with another base station, and the other base station belongs to a second communication system. The first communication system and the second communication system may belong to a same operator network, or may belong to different operator networks.

In an embodiment, the configuration information can be generated by the base station, or can be specified by a protocol in advance. The base station sends the configuration information to the terminal to allow the terminal to determine the configuration. Specifically, the terminal can determine, when communicating with the base station through the first SIM card, the configuration for the first SIM card to leave the first communication system of the base station when the communication conflict occurs between the first SIM card and the second SIM card.

According to embodiments of the present disclosure, by acquiring the configuration information from the base station, the terminal can determine a configuration for the first SIM card to leave the first communication system when the communication conflict occurs between the first SIM card and the second SIM card. Since the configuration information is determined by the base station, the base station controls, through the configuration information, an operation for the first SIM card to leave the first communication system, and can also determine, based on the configuration information, how the first SIM card to leave the first communication system.

When the terminal uses the first SIM card to communicate with the base station, and if in the meantime, a communication conflict occurs between the first SIM card and the second SIM card, the first SIM card can be controlled according to the configuration to leave the first communication system of the base station, and when the first SIM card leaves the communication system, the terminal can communicate in a second communication system through a second SIM card, such as receiving pages, responding to pages, receiving system information, tracking area updates, etc.

Since the base station can determine how the first SIM card to leave the first communication system, when the first SIM card leaves the first communication system according to the configuration, the base station can determine that the communication conflict occurs between the first SIM card and the second SIM card in the terminal, which causes the first SIM card to leave the first communication system. Further, the base station can wait the first SIM card to return to the first communication system according to the configuration, and does not need to page the first SIM card or boost power, which is not only beneficial to avoiding waste of communication resources, but also improves controllability for the first SIM card to leave the first communication system.

It is to be noted that, there may be two cases when the first SIM card leaves the first communication system.

One case refers to that a connected state between the first SIM card and the base station is disconnected, and the first SIM card enters an idle state or an inactive state.

The other case refers to that a current state between the first SIM card and the base station is the connected state, or the idle state, or the inactive state, and leaving the first communication system refers to that the first SIM card and the base station still remain the current state, but within a short period (for example, a period less than a preset time length) a downlink channel is not monitored, and no uplink transmission is performed.

In addition, the communication conflict occurring between the first SIM card and the second SIM card may refer to that the terminal determines that a communication conflict is currently occurring between the first SIM card and the second SIM card, or may refer to that the terminal predicts that a communication conflict is about to happen between the first SIM card and the second SIM card.

In an embodiment, the communication conflict between the first SIM card and the second SIM card includes but is not limited to following cases:
a conflict occurs between page information monitoring of the first SIM card and page information monitoring of the second SIM card, for example, paging occasions overlap with each other; and following cases mainly refer to that when the first SIM card performs a communication operation, the second SIM card needs to perform a communication operation:
a conflict occurs between the communication operation of the first SIM card and the paging information monitoring of the second SIM card;
a conflict occurs between the communication operation of the first SIM card and the paging information responding of the second SIM card;
a conflict occurs between the communication operation of the first SIM card and signal measuring of the second SIM card;
a conflict occurs between the communication operation of the first SIM card and system information receiving of the second SIM card; and/or
a conflict occurs between the communication operation of the first SIM card and tracking area updating of the second SIM card.

In an embodiment, before receiving the configuration information sent by the base station, the method further includes:
sending trigger information for acquiring the configuration information to the base station.

In view of this, the terminal sends the trigger information to the base station when the terminal needs to acquire the configuration information, and further the base station will send the configuration information to the multi-card terminal, which is beneficial to avoiding resources being wasted caused by that the base station sends the configuration information to the terminal when the terminal does not need the configuration information.

In some embodiments, the trigger information includes at least one of the following:
the terminal is provided with a plurality of SIM cards;
when the terminal uses the first SIM card to communicate with the base station, the second SIM card is in an ON state;
when the terminal uses the first SIM card to communicate with the base station, the second SIM card receives information of a service to be started; or
when the terminal uses the first SIM card to communicate with the base station, the communication conflict occurs between the first SIM card and the second SIM card.

In an embodiment, the trigger information sent by the terminal may be one of the above 4 cases. After receiving the trigger information, the base station can further analyse the specific trigger information, and send the configuration information to the terminal when the trigger information is target information, where the target information may be one or more of the above 4 cases.

For example, the target information may be that when the terminal uses the first SIM card to communicate with the base station, the communication conflict occurs between the first SIM card and the second SIM card, and the trigger information sent by the terminal to the base station is that the terminal is provided with a plurality of SIM cards, and the base station can determine that the received trigger information is not consistent with the target information, and will not send the configuration information to the terminal.

It is to be noted that, the trigger information may be sent by the terminal according to its own state. For example, when the second SIM card is in an OFF state, the reported trigger information is that the terminal is provided with a plurality of SIM cards; when the second SIM card is in an ON state but does not receive the information of the service to be started yet, the reported trigger information is that the second SIM card is in the ON state when the terminal uses the first SIM card to communicate with the base station; and so on.

The base station can determine an urgent level of the communication conflict between the first SIM card and the second SIM card in the terminal by analysing the trigger information. For example, when an urgent level of the received trigger information is higher than an urgent level of the target information, even though the trigger information is different from the target information, the base station can still send the configuration information to the terminal.

For example, the target information is that the second SIM card receives the information of the service to be started when the terminal uses the first SIM card to communicate with the base station, and the received trigger information is that the communication conflict occurs between the first SIM card and the second SIM card when the terminal uses the first SIM card to communicate with the base station, the base station can determine that the urgent level of the trigger information is higher than the urgent level of the target information, and send the configuration information to the terminal.

In an embodiment, the base station can send the trigger information to the base station for once, or can send the configuration information to the base station for several times as a state of the terminal changes. For example, when the trigger information is sent but no configuration information is received last time, the trigger information can be sent again.

For example, when the second SIM card is in an OFF state, the trigger information sent by the terminal to the base station may be that the terminal is provided with a plurality of SIM cards; when no configuration information is received, the terminal can send the trigger information to the base station again after the second SIM card turns to an ON state, and the sent trigger information is that the second SIM card is in the ON state when the terminal uses the first SIM card to communicate with the base station; when no configuration information is received, the terminal can send the trigger information to the base station again after the second SIM card receives the information of the service to be started, and the sent trigger information is that the second SIM card receives the information of the service to be started when the terminal uses the first SIM card to communicate with the base station; when no configuration information is received, the terminal can send the trigger information to the base station again when the communication conflict occurs between the first SIM card and the second SIM card, and the sent trigger information is that the communication conflict occurs between the first SIM card and the second SIM card when the terminal uses the first SIM card to communicate with the base station.

In some embodiments, the configuration for the first SIM card to leave the first communication system includes at least one of the following:
a condition for the first SIM card to leave the first communication system;
a determination manner of a period of time for the first SIM card to leave the first communication system; or
a determination manner of a cycle for the first SIM card to leave the first communication system.

In an embodiment, the configuration for the first SIM card to leave the first communication system may include the condition for the first SIM card to leave the first communication system. That is, when the condition is satisfied, the first SIM card can leave the first communication system, and when the condition is not satisfied, the first SIM card cannot leave the first communication system. In view of this, the base station can effectively control the first SIM card to leave the first communication system, and under what conditions the first SIM card can leave the first communication system.

In an embodiment, the configuration for the first SIM card to leave the first communication system may include the determination manner of the period of time for the first SIM card to leave the first communication system, and may include the determination manner of the cycle for the first SIM card to leave the first communication system, etc. That is, the base station can inform the terminal through the configuration information of how to determine the period of time and the cycle for the first SIM card to leave the first communication system, so as to effectively control how the first SIM card to leave the first communication system.

In some embodiments, when the communication conflict occurs between the first SIM card and the second SIM card, the first SIM card performs communication of a first service, the second SIM card performs communication of a second service, and the condition for the first SIM card to leave the first communication system includes at least one of:
a relation between an attribute of the first service and an attribute of the second service satisfies a first condition;
the attribute of the first service does not satisfy a second condition; or
the attribute of the second service satisfies a third condition.

It is to be noted that, a case that the first SIM card performs communication of the first service and the second SIM card performs communication of the second service refers to that the first SIM card is currently performing communication of the first service and the second SIM card is about to perform or is currently performing communication of the second service.

In some embodiments, the attribute includes one of the following:
a service priority, a service quality (or a quality-of-service class identifier, QCI) and a service identifier.

The service priority may be agreed by the base station and the terminal, or may also be specified by a protocol; the service identifier may specifically be a service name, or a code agreed by the terminal and the base station.

In an embodiment, the condition for the first SIM card to leave the first communication system can be determined based on the attribute of the first service and the attribute of the second service, which may specifically refer to that a relation between the attribute of the first service and the attribute of the second service satisfies a first condition.

Different attributes correspond to different first conditions. For example, when the attribute is the service priority, the first condition may be that the priority of the second service is higher than the priority of the first service, or a difference between the higher priority of the second service and the lower priority of the first service is greater than a specified difference; for example, when the attribute is the quality of service (QoS), the first condition may be a QoS of the second service is higher than a QoS of the first service, or a difference between a higher QCI of the second service and a lower QCI of the first service is greater than a specified value.

In an embodiment, the condition for the first SIM card to leave the first communication system may be determined based on the attribute of the first service, which may specifically refer to that the attribute of the first service does not satisfy a second condition, that is, when the attribute of the first service satisfies the second condition, the first SIM card will not leave the first communication system.

Different attributes correspond to different second conditions. For example, when the attribute is the service identifier, the second condition may be that the identifier of the first service is not a target identifier. For example, a service with the target identifier is a voice call service, then when the terminal uses the first SIM card to perform the voice call service, even though the communication conflict occurs between the first SIM card and the second SIM card, the first SIM card cannot leave the first communication system, so as to ensure quality of the voice call, and when a non-voice-call service is performed, the first SIM card can leave the first communication system, so as to allow the second SIM card to communicate in the second communication system.

In an embodiment, the condition for the first SIM card to leave the first communication system may be determined based on the attribute of the second service, which may specifically refer to that the attribute of the second service satisfies the third condition.

Different attributes correspond to different third conditions. For example, when the attribute is the priority of the service, the third condition may be that the priority of the second service is higher than a priority threshold. When the terminal uses the first SIM card to perform the voice call service with the base station, and the communication conflict occurs between the first SIM card and the second SIM card, then the first SIM card can leave the first communication system, so as to allow the second SIM card to communicate in the second communication system.

In some embodiments, when the communication conflict occurs between the first SIM card and the second SIM card, the first SIM card performs communication of a first service, the second SIM card performs communication of a second service, and the determination manner of the period of time for the first SIM card to leave the first communication system includes at least one of:
determining the period of time according to a relation between an attribute of the first service and an attribute of the second service;
determining the period of time according to the attribute of the first service; or
determining the period of time according to the attribute of the second service.

In an embodiment, when the communication conflict occurs between the first SIM card and the second SIM card, the terminal can control the first SIM card to leave the first communication system for a period of time, and use the second SIM card to communicate in the second communication system within the period of time, and then control the second SIM card to leave the second communication system after the period of time, and control the first SIM card to return to the first communication system.

In an embodiment, the period of time for the first SIM card to leave the first communication system can be determined based on a relation between the attribute of the first service and the attribute of the second service.

For example, the attribute is the service priority, and when the priority of the first service is lower than the priority of the second service, the period of time for the first SIM card to leave the first communication system can be determined as t1, and when the priority of the first service is higher than the priority of the second service, the period of time for the first SIM card to leave the first communication system can be determined as t2, where t2>t1. That is, higher the priority of the first service is, shorter the period of time of leaving is, which is beneficial to ensuring communication quality of services with higher priority.

In an embodiment, the period of time for the first SIM card to leave the first communication system can be determined based on the attribute of the first service.

For example, when the attribute is the identifier of the service, for an identifier of each service, a corresponding relation between the identifier and the period of time can be determined in advance. For example, the base station configures a first table for the terminal, where the first table includes corresponding relations between identifiers and periods of time, and the terminal can determine the period of time corresponding to the identifier of the first service according to the corresponding relations, so that when the communication conflict occurs between the first SIM card and the second SIM card, the terminal can control the first SIM card to leave the first communication system for the period of time, and use the second SIM card to communicate in the second communication system within the period of time, and after the period of time, control the first SIM card to return to the first communication system.

In an embodiment, the period of time for the first SIM card to leave the first communication system can be determined based on the attribute of the second service.

For example, when the attribute is the service quality, for an identifier of each service, a corresponding relation between the service quality and the period of time can be determined in advance. For example, the base station configures a second table for the terminal, where the second table includes corresponding relations between identifiers and periods of time, and the terminal can determine the period of time corresponding to the service quality of the second service according to the corresponding relations, so that when the communication conflict occurs between the first SIM card and the second SIM card, the terminal can control the first SIM card to leave the first communication system for the period of time, and use the second SIM card to communicate in the second communication system within the period of time, and after the period of time, control the first SIM card to return to the first communication system.

In some embodiments, when the communication conflict occurs between the first SIM card and the second SIM card, the first SIM card performs communication of a first service, the second SIM card performs communication of a second service, and the determination manner of the cycle for the first SIM card to leave the first communication system includes at least one of:
determining the cycle according to a relation between an attribute of the first service and an attribute of the second service;
determining the cycle according to the attribute of the first service; or
determining the cycle according to the attribute of the second service.

In an embodiment, when the communication conflict occurs between the first SIM card and the second SIM card, the terminal can control the first SIM card to leave the first communication system periodically, and use the second SIM card to communicate in the second communication system during a cycle when the first SIM card left the first communication system, and then control the second SIM card to leave the second communication system after the cycle, and control the first SIM card to return to the first communication system.

In an embodiment, the cycle for the first SIM card to leave the first communication system can be determined based on a relation between the attribute of the first service and the attribute of the second service.

For example, the attribute is the service priority, and when the priority of the first service is lower than the priority of the second service, the cycle for the first SIM card to leave the first communication system can be determined as T1, and when the priority of the first service is higher than the priority of the second service, the cycle for the first SIM card to leave the first communication system can be determined as T2, where T2>T1. That is, higher the priority of the first service is, shorter the cycle of leaving is, which is beneficial to ensuring communication quality of services with higher priority.

In an embodiment, the cycle for the first SIM card to leave the first communication system can be determined based on the attribute of the first service.

For example, when the attribute is the identifier of the service, for an identifier of each service, a corresponding relation between the identifier and the cycle can be determined in advance. For example, the base station configures a third table for the terminal, where the third table includes corresponding relations between identifiers and cycles, and the terminal can determine the cycle corresponding to the identifier of the first service according to the corresponding relations, so that when the communication conflict occurs between the first SIM card and the second SIM card, the terminal can control the first SIM card to leave the first communication system based on the cycle.

In an embodiment, the cycle for the first SIM card to leave the first communication system can be determined based on the attribute of the second service.

For example, when the attribute is the service quality, for an identifier of each service, a corresponding relation between the service quality and the cycle can be determined in advance. For example, the base station configures a fourth table for the terminal, where the fourth table includes corresponding relations between identifiers and cycles, and the terminal can determine the cycle corresponding to the service quality of the second service according to the corresponding relations, so that when the communication conflict occurs between the first SIM card and the second SIM card, the terminal can control the first SIM card to leave the first communication system based on the cycle.

Corresponding to the embodiments of the above configuration information sending method and the above configuration determination method, the present disclosure further provides embodiments of a configuration information sending apparatus and a configuration determination apparatus.

FIG. 3 is a schematic block diagram of a configuration information sending apparatus according to an embodiment of the present disclosure. The configuration information sending apparatus described by the present embodiment can be applied to a base station, and the base station includes but is not limited to a 4G base station, a 5G base station, a 6G base station. The base station can communicate with a terminal as a user equipment, including but not limited to mobile phones, tablet computers, wearable devices, sensors, Internet of Things devices and other communication devices.

In an embodiment, the base station may belong to a first communication system, the base station can communicate with the terminal, the terminal is provided with a plurality of SIM cards. In the following, a circumstance that the plurality of SIM cards include a first SIM card and a second SIM card will be mainly illustrated.

The first SIM card and the second SIM card do not refer to a certain SIM card, but refer to any two different SIM cards in the plurality of SIM cards. The SIM card may be a traditional SIM card, a USIM card, an eSIM card, etc.

As shown in FIG. 3, the configuration information sending apparatus may include:
a configuration-sending module 301, configured to send configuration information to a multi-card terminal;
where the configuration information is used for the terminal to determine a configuration for a first SIM card to leave a first communication system of the base station when a communication conflict occurs between the first SIM card and a second SIM card during communicating with the base station through the first SIM card.

In an embodiment, the configuration-sending module is configured to, in response to receiving trigger information for acquiring the configuration information sent by the terminal, send the configuration information to the terminal.

In an embodiment, the trigger information includes at least one of the following:
the terminal is provided with a plurality of SIM cards;
when the terminal uses the first SIM card to communicate with the base station, the second SIM card is in an ON state;
when the terminal uses the first SIM card to communicate with the base station, the second SIM card receives information of a service to be started; or
when the terminal uses the first SIM card to communicate with the base station, the communication conflict occurs between the first SIM card and the second SIM card.

In an embodiment, the configuration for the first SIM card to leave the first communication system includes at least one of the following:
a condition for the first SIM card to leave the first communication system;
a determination manner of a period of time for the first SIM card to leave the first communication system; or
a determination manner of a cycle for the first SIM card to leave the first communication system.

In an embodiment, when the communication conflict occurs between the first SIM card and the second SIM card, the first SIM card performs communication of a first service, the second SIM card performs communication of a second service, and the condition for the first SIM card to leave the first communication system includes at least one of:
a relation between an attribute of the first service and an attribute of the second service satisfies a first condition;
the attribute of the first service does not satisfy a second condition; or
the attribute of the second service satisfies a third condition.

In an embodiment, when the communication conflict occurs between the first SIM card and the second SIM card, the first SIM card performs communication of a first service, the second SIM card performs communication of a second service, and the determination manner of the period of time for the first SIM card to leave the first communication system includes at least one of:
determining the period of time according to a relation between an attribute of the first service and an attribute of the second service;
determining the period of time according to the attribute of the first service; or
determining the period of time according to the attribute of the second service.

In an embodiment, when the communication conflict occurs between the first SIM card and the second SIM card, the first SIM card performs communication of a first service, the second SIM card performs communication of a second service, and the determination manner of the cycle for the first SIM card to leave the first communication system includes at least one of:
determining the cycle according to a relation between an attribute of the first service and an attribute of the second service;
determining the cycle according to the attribute of the first service; or
determining the cycle according to the attribute of the second service.

In an embodiment, the attribute includes one of the following:
a service priority, a service quality and a service identifier.

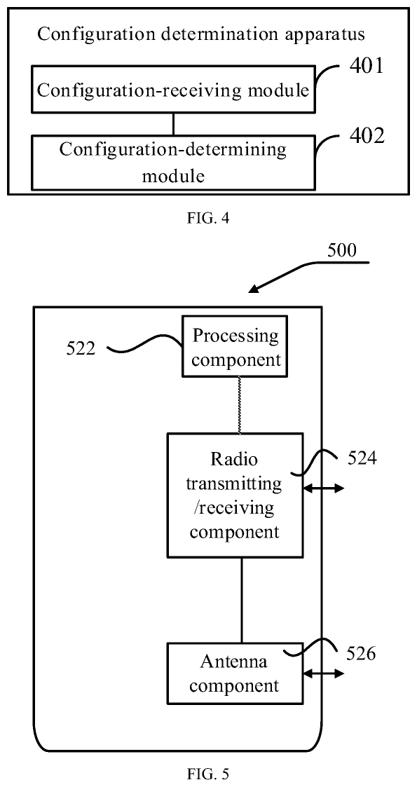

FIG. 4 is a schematic block diagram of a configuration determination apparatus according to an embodiment of the present disclosure. The configuration determination apparatus described in the present embodiment can be applied to a terminal, where the terminal includes but is not limited to mobile phones, tablet computers, wearable devices, sensors, Internet of Things devices and other communication devices. The terminal can serve as a user equipment to communicate with a base station, where the base station includes but is not limited to a 4G base station, a 5G base station and a 6G base station.

In an embodiment, the base station may belong to a first communication system, the base station can communicate with the terminal, the terminal is provided with a plurality of SIM cards. In the following, a circumstance that the plurality of SIM cards include a first SIM card and a second SIM card will be mainly illustrated.

The first SIM card and the second SIM card do not refer to a certain SIM card, but refer to any two different SIM cards in the plurality of SIM cards. The SIM card may be a traditional SIM card, a USIM card, an eSIM card, etc.

As shown in FIG. 4, the configuration determination apparatus may include:
a configuration-receiving module 401, configured to receive configuration information sent by a base station;
a configuration-determining module 402, configured to determine a configuration for a first SIM card to leave a first communication system of the base station according to the configuration information when a communication conflict occurs between the first SIM card and a second SIM card when the terminal communicates with the base station through the first SIM card.

In an embodiment, before the configuration information sent by the base station is received, the apparatus further includes:
a trigger-sending module, configured to send trigger information for acquiring the configuration information to the base station.

In an embodiment, the trigger information includes at least one of the following:
the terminal is provided with a plurality of SIM cards;
when the terminal uses the first SIM card to communicate with the base station, the second SIM card is in an ON state;
when the terminal uses the first SIM card to communicate with the base station, the second SIM card receives information of a service to be started; or
when the terminal uses the first SIM card to communicate with the base station, the communication conflict occurs between the first SIM card and the second SIM card.

In an embodiment, the configuration for the first SIM card to leave the first communication system includes at least one of the following:
a condition for the first SIM card to leave the first communication system;
a determination manner of a period of time for the first SIM card to leave the first communication system; or
a determination manner of a cycle for the first SIM card to leave the first communication system.

In an embodiment, when the communication conflict occurs between the first SIM card and the second SIM card, the first SIM card performs communication of a first service, the second SIM card performs communication of a second service, and the condition for the first SIM card to leave the first communication system includes at least one of:
a relation between an attribute of the first service and an attribute of the second service satisfies a first condition;
the attribute of the first service does not satisfy a second condition; or
the attribute of the second service satisfies a third condition.

In an embodiment, when the communication conflict occurs between the first SIM card and the second SIM card, the first SIM card performs communication of a first service, the second SIM card performs communication of a second service, and the determination manner of the period of time for the first SIM card to leave the first communication system includes at least one of:
determining the period of time according to a relation between an attribute of the first service and an attribute of the second service;
determining the period of time according to the attribute of the first service; or
determining the period of time according to the attribute of the second service.

In an embodiment, when the communication conflict occurs between the first SIM card and the second SIM card, the first SIM card performs communication of a first service, the second SIM card performs communication of a second service, and the determination manner of the cycle for the first SIM card to leave the first communication system includes at least one of:
determining the cycle according to a relation between an attribute of the first service and an attribute of the second service;
determining the cycle according to the attribute of the first service; or
determining the cycle according to the attribute of the second service.

In an embodiment, the attribute includes one of the following:
a service priority, a service quality and a service identifier.

With regard to the apparatus in the above embodiments, specific ways in which each module performs operations have been described in detail in the embodiment of related methods, and will not be described in detail here.

Since the apparatus embodiments basically correspond to the method embodiments, relevant content can be referred to from parts of description of the method embodiments. The apparatus embodiments described above are only illustrative, where the modules described as separate components may or may not be physically separated, and the components displayed as modules may or may not be physical modules, that is, they may be located in one place or distributed to multiple network modules. Some or all of the modules can be selected according to actual needs to achieve the purpose of the present embodiment. Those of ordinary skills in the art can understand and implement the embodiment without making creative efforts.

Embodiments of the present disclosure further provide a communication device, including:
a processor;
a memory configured to store a computer program;
when the computer program is executed by the processor, the above configuration information sending method according to any embodiment is implemented.

Embodiments of the present disclosure further provide a communication device, including:
a processor;
a memory configured to store a computer program;
when the computer program is executed by the processor, the above configuration determination method according to any embodiment is implemented.

Embodiments of the present disclosure further provides a computer-readable storage medium configured to store a computer program, and when the computer program is executed by a processor, steps in the above configuration information sending method according to any embodiment are implemented.

Embodiments of the present disclosure further provides a computer-readable storage medium configured to store a computer program, and when the computer program is executed by a processor, steps in the above configuration determination method according to any embodiment are implemented.

As shown in FIG. 5, FIG. 5 is a schematic block diagram of a device for sending configuration information according to an embodiment of the present disclosure. A device 500 can be provided as a base station. As shown in FIG. 5, the device 500 includes a processing component 522, a radio transmitting/receiving component 524, an antenna component 526, and a specific signal processing part of a radio interface, where the processing component 522 may further include one or more processors. A processor in the processing component 522 can be configured to implement the configuration information sending method according to any one of the above embodiments.

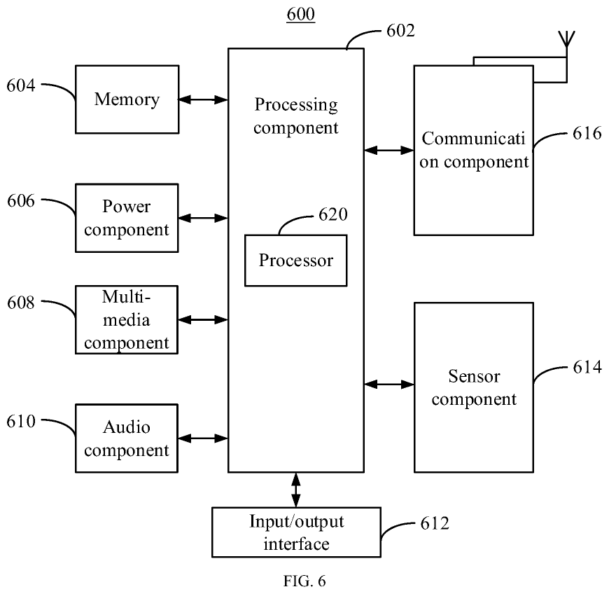

FIG. 6 is a schematic block diagram of a device 600 for determining a configuration according to an embodiment of the present disclosure. For example, the device 600 can be a mobile phone, a computer, a digital broadcasting terminal, a messaging device, a game console, a tablet device, a medical device, a fitness device, a personal digital assistant and the like.

As shown in FIG. 6, the device 600 may include one or more of the following components: a processing component 602, a memory 604, a power component 606, a multimedia component 608, an audio component 610, an input/output (1/O) interface 612, a sensor component 614, and a communication component 616.

The processing component 602 generally controls overall operations of the device 600, such as operations associated with display, telephone call, data communication, camera operation and recording operation. The processing component 602 may include one or more processors 620 to execute instructions to complete all or part of steps of the configuration determination method described above. The processing component 602 may include one or more modules to facilitate interaction between the processing component 602 and other components. For example, the processing component 602 can include a multimedia module to facilitate interaction between the multimedia component 608 and the processing component 602.

The memory 604 is configured to store various types of data to support operations at the device 600. Examples of these data include instructions for any application or method operating on the device 600, such as contact data, phone book data, messages, pictures, videos, and the like. The memory 604 can be realized by any type of volatile or non-volatile memory device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power supply component 606 provides power to various components of the device 600. The power component 606 may include a power management system, one or more power sources, and other components associated with generating, managing and distributing power for the device 600.

The multimedia component 608 includes a screen that provides an output interface between the device 600 and the user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touch, sliding and gestures on the touch panel. The touch sensor may not only sense a boundary of a touch or sliding action, but also detect a duration and a pressure related to the touch or sliding operation. In some embodiments, the multimedia component 608 includes a front camera and/or a rear camera. When the device 600 is in an operation mode, such as a shooting mode or a video mode, the front camera and/or the rear camera can receive external multimedia data. Each front camera and rear camera can be a fixed optical lens system or has focal length and optical zoom capability.

The audio component 610 is configured to output and/or input audio signals. For example, the audio component 610 includes a microphone (MIC) configured to receive external audio signals when the device 600 is in the operation mode, such as a call mode, a recording mode and a voice recognition mode. The received audio signal may be further stored in the memory 604 or transmitted via the communication component 616. In some embodiments, the audio component 610 further includes a speaker for outputting audio signals.

The I/O interface 612 provides an interface between the processing component 602 and peripheral interface modules, which may be keyboards, click-wheels, buttons, etc. These buttons may include, but are not limited to, home button, volume button, start button and lock button.

The sensor component 614 includes one or more sensors for providing various aspects of state evaluation for the device 600. For example, the sensor component 614 can detect the on/off state of the device 600, the relative positioning of components, such as the display and keypad of the device 600, a position change of the device 600 or a component of the device 600, presence or absence of user contact with the device 600, an orientation or acceleration/deceleration of the device 600 and a temperature change of the device 600. The sensor component 614 may include a proximity sensor configured to detect presence of a nearby object without any physical contact. The sensor component 614 may also include an optical sensor, such as a CMOS or CCD image sensor, for use in imaging applications. In some embodiments, the sensor component 614 may further include an acceleration sensor, a gyro sensor, a magnetic sensor, a pressure sensor or a temperature sensor.

The communication component 616 is configured to facilitate wired or wireless communication between the device 600 and other devices. The device 600 can access a wireless network based on communication standards, such as WiFi, 2G or 3G, 4G LTE, 5G NR or their combination. In an exemplary embodiment, the communication component 616 receives a broadcast signal or broadcast related information from an external broadcast management system via a broadcast channel. In an exemplary embodiment, the communication component 616 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the device 600 may be implemented by one or more application-specific integrated circuits (ASIC), digital signal processors (DSP), digital signal processing devices (DSPD), programmable logic devices (PLD), field programmable gate arrays (FPGA), controllers, micro-controllers, microprocessors or other electronic components for performing the above configuration determination method.

In an exemplary embodiment, there is also provided a non-transitory computer-readable storage medium including instructions, such as the memory 604 including instructions, which can be executed by the processor 620 of the device 600 to complete the configuration determination method described above. For example, the non-transitory computer-readable storage medium can be a read-only memory (ROM), a random access memory (RAM), a CD-ROM, a magnetic tape, a floppy disk, an optical data storage device, etc.

Those skilled in the art can easily think of other embodiments after considering the disclosure of the specification and embodiments. The present disclosure is intended to cover any variations, uses or adaptations of the present disclosure, which follow the general principles of the present disclosure and include common sense or common technical means in the technical field that are not disclosed in the present disclosure. The specification and embodiments are to be regarded as illustrative only, with the true scope and spirit of the present disclosure being indicated by the following claims.

It should be understood that the present disclosure is not limited to the precise structure described above and shown in the drawings, and various modifications and changes can be made without departing from its scope. The scope of the present disclosure is limited only by the appended claims.

It should be noted that relational terms used herein such as first and second are only used to distinguish one entity or operation from another entity or operation, and do not necessarily require or imply that there is any such actual relationship or order between these entities or operations. The terms “including”, “comprising” or any other variation thereof are intended to cover non-exclusive inclusion, so that a process, method, article or equipment including a series of elements includes not only those elements, but also other elements not explicitly listed or elements inherent to such process, method, article or device. Without further restrictions, an element defined by the phrase “including a” does not exclude the existence of other identical elements in the process, method, article or device including the element.

The method and apparatus provided by the embodiment of the present disclosure are described in detail above, and the principle and implementation of the present disclosure are expounded with specific examples herein. The description of the above embodiments is only used to help understand the method and its core idea of the present disclosure. At the same time, according to the idea of the present disclosure, there will be changes in the specific implementation and application scope for those of ordinary skills in this field. To sum up, the contents of this specification should not be understood as limitations to the present disclosure.

1. A configuration information sending method, performed by a base station and the method comprises:
sending configuration information to a multi-card terminal;
wherein the configuration information is used for the multi-card terminal to determine a configuration for a first subscriber identity module (SIM) card of the multi-card terminal to leave a first communication system of the base station on a condition that a communication conflict occurs between the first SIM card and a second SIM card of the multi-card terminal during communication with the base station through the first SIM card.

2. The method according to claim 1, wherein sending the configuration information to the multi-card terminal comprises:
in response to receiving trigger information for acquiring the configuration information sent by the multi-card terminal, sending the configuration information to the multi-card terminal.

3. The method according to claim 2, wherein the trigger information comprises at least one of:
the multi-card terminal is provided with a plurality of SIM cards;
when the multi-card terminal uses the first SIM card to communicate with the base station, the second SIM card is in an ON state;
when the multi-card terminal uses the first SIM card to communicate with the base station, the second SIM card receives information of a service to be started; or
when the multi-card terminal uses the first SIM card to communicate with the base station, the communication conflict occurs between the first SIM card and the second SIM card.

4. The method according to claim 1, wherein the configuration for the first SIM card to leave the first communication system comprises at least one of:
a condition for the first SIM card to leave the first communication system;
a determination manner of a period of time for the first SIM card to leave the first communication system; or
a determination manner of a cycle for the first SIM card to leave the first communication system.

5. The method according to claim 4, wherein on the condition that the communication conflict occurs between the first SIM card and the second SIM card, the first SIM card performs communication of a first service, the second SIM card performs communication of a second service, and the condition for the first SIM card to leave the first communication system comprises at least one of:
a relation between an attribute of the first service and an attribute of the second service satisfies a first condition;
the attribute of the first service does not satisfy a second condition; or
the attribute of the second service satisfies a third condition.

6. The method according to claim 4, wherein on the condition that the communication conflict occurs between the first SIM card and the second SIM card, the first SIM card performs communication of a first service, the second SIM card performs communication of a second service, and the determination manner of the period of time for the first SIM card to leave the first communication system comprises at least one of:
determining the period of time according to a relation between an attribute of the first service and an attribute of the second service;
determining the period of time according to the attribute of the first service; or
determining the period of time according to the attribute of the second service.

7. The method according to claim 4, wherein on the condition that the communication conflict occurs between the first SIM card and the second SIM card, the first SIM card performs communication of a first service, the second SIM card performs communication of a second service, and the determination manner of the cycle for the first SIM card to leave the first communication system comprises at least one of:
determining the cycle according to a relation between an attribute of the first service and an attribute of the second service;
determining the cycle according to the attribute of the first service; or
determining the cycle according to the attribute of the second service.

8. The method according to claim 5, wherein
the attribute of the first service comprises one of:
a priority of the first service, a service quality of the first service, and an identifier of the first service; and
the attribute of the second service comprises one of:
a priority of the second service, a service quality of the second service, and an identifier of the second service.

9. A configuration determination method performed by a multi-card terminal and the method comprises:
receiving configuration information sent by a base station;
determining a configuration for a first subscriber identity module (SIM) card of the multi-card terminal to leave a first communication system of the base station according to the configuration information on a condition that a communication conflict occurs between the first SIM card and a second SIM card of the multi-card terminal during communicating with the base station through the first SIM card.

10. The method according to claim 9, wherein before receiving the configuration information sent by the base station, the method further comprises:
sending trigger information for acquiring the configuration information to the base station.

11. The method according to claim 10, wherein the trigger information comprises at least one of:
the multi-card terminal is provided with a plurality of SIM cards;
when the multi-card terminal uses the first SIM card to communicate with the base station, the second SIM card is in an ON state;
when the multi-card terminal uses the first SIM card to communicate with the base station, the second SIM card receives information of a service to be started; or
when the multi-card terminal uses the first SIM card to communicate with the base station, the communication conflict occurs between the first SIM card and the second SIM card.

12. The method according to claim 9, wherein the configuration for the first SIM card to leave the first communication system comprises at least one of:
a condition for the first SIM card to leave the first communication system;
a determination manner of a period of time for the first SIM card to leave the first communication system; or
a determination manner of a cycle for the first SIM card to leave the first communication system.

13. The method according to claim 12, wherein on the condition that the communication conflict occurs between the first SIM card and the second SIM card, the first SIM card performs communication of a first service, the second SIM card performs communication of a second service, and the condition for the first SIM card to leave the first communication system comprises at least one of:
a relation between an attribute of the first service and an attribute of the second service satisfies a first condition;
the attribute of the first service does not satisfy a second condition; or
the attribute of the second service satisfies a third condition.

14. The method according to claim 12, wherein on the condition that the communication conflict occurs between the first SIM card and the second SIM card, the first SIM card performs communication of a first service, the second SIM card performs communication of a second service, and the determination manner of the period of time for the first SIM card to leave the first communication system comprises at least one of:
determining the period of time according to a relation between an attribute of the first service and an attribute of the second service;
determining the period of time according to the attribute of the first service; or
determining the period of time according to the attribute of the second service.

15. The method according to claim 12, wherein on the condition that the communication conflict occurs between the first SIM card and the second SIM card, the first SIM card performs communication of a first service, the second SIM card performs communication of a second service, and the determination manner of the cycle for the first SIM card to leave the first communication system comprises at least one of:
determining the cycle according to a relation between an attribute of the first service and an attribute of the second service;
determining the cycle according to the attribute of the first service; or
determining the cycle according to the attribute of the second service.

16. The method according to claim 13, wherein
the attribute of the first service comprises one of:
a priority of the first service, a service quality of the first service, and an identifier of the first service; and
the attribute of the second service comprises one of:
a priority of the second service, a service quality of the second service, and an identifier of the second service.

17-18. (canceled)

19. A base station, comprising:
a processor; and
a memory configured to store a computer program, and
the processor is configured to execute the computer program to implement the configuration information sending method according to claim 1.

20. A multi-card terminal, comprising:
a processor; and
a memory configured to store a computer program, and;
the processor is configured to execute the computer program to implement operations comprising:
receiving configuration information sent by a base station; and
determining a configuration for a first subscriber identity module (SIM) card of the multi-card terminal to leave a first communication system of the base station according to the configuration information on a condition that a communication conflict occurs between the first SIM card and a second SIM card of the multi-card terminal during communication with the base station through the first SIM card.

21. A non-transitory computer-readable storage medium, configured to store a computer program, wherein when the computer program is executed by a processor, the configuration information sending method according to claim 1 is implemented.

22. A non-transitory computer-readable storage medium, configured to store a computer program, wherein the computer program is executed by a processor, the configuration determination method according to claim 9 is implemented.
